(19) United States
(12) Patent Application Publication
(10) Pub. No.: US 2025/0164447 A1
(43) Pub. Date: May 22, 2025

(54) MEMS TAPPING-MODE CANTILEVER AS ACOUSTIC NANOFORCE SENSOR

(71) Applicant: Hahn-Schickard-Gesellschaft für angewandte Forschung e. V., Stuttgart (DE)

(72) Inventors: Achim Bittner, Heilbronn (DE); Daniel Biesinger, Villingen-Schwenningen (DE)

(21) Appl. No.: 18/840,457

(22) PCT Filed: Feb. 16, 2023
(86) PCT No.: PCT/EP2023/053859

§ 371 Date: Aug. 21, 2024

(30) Foreign Application Priority Data
Feb. 24, 2022 (EP) 22158393.3

(51) Int. Cl. G01N 29/24; G01N 29/02; H04R 1/08

(52) U.S. Cl. CPC G01N 29/2425; G01N 29/022; G01N 2291/021; H04R 1/08; H04R 2201/003

(57) ABSTRACT

In a first aspect, the invention relates to a MEMS microphone for detecting acoustic signals. The MEMS microphone exhibits a vibratable microphone membrane which is induced into vibrations by sound waves passing through a sound inlet opening. Furthermore, the MEMS microphone exhibits a cantilever comprising a measuring tip. The cantilever is actively induced into vibrations by an actuator such that the measuring tip is guided to the microphone membrane in a contactless vibrating manner. A tunnel current flows between the microphone membrane and the measuring tip, with which the vibration behavior of the microphone membrane, which is dependent on the sound waves, can be detected. An electronic circuit is configured to measure the tunnel current between the microphone membrane and the measuring tip. The MEMS microphone according to the invention makes it possible to detect particularly low sound pressure levels with high resolution.

In a further aspect, the invention relates to methods for detecting acoustic signals using the MEMS microphone according to the invention.

The invention relates to the technical field of MEMS microphones. In a first aspect, the invention relates to a MEMS microphone for detecting acoustic signals. The MEMS microphone exhibits a vibratable microphone membrane which is induced into vibrations by sound waves passing through a sound inlet opening. Furthermore, the MEMS microphone exhibits a cantilever comprising a measuring tip. The cantilever is actively induced into vibrations by an actuator such that the measuring tip is guided to the microphone membrane in a contactless vibratable manner. A tunnel current flows between the microphone membrane and the measuring tip, with which the vibration behavior of the microphone membrane, which depends on the sound waves, can be detected. An electronic circuit is configured to measure the tunnel current between the microphone membrane and the measuring tip. The MEMS microphone according to the invention makes it possible to detect particularly low sound pressure levels with high resolution.

In a further aspect, the invention relates to methods for detecting acoustic signals using the MEMS microphone according to the invention.

### BACKGROUND AND PRIOR ART

Microphones are electro-acoustic transducers that convert a sound event, i.e. occurring sound waves, into an electrical signal. The electrical signal corresponds to the acoustic input signal. In the prior art, there are a variety of designs and functions of different types of microphones, each of which fulfills different application purposes and functions.

In particular, extremely compact microphones based on MEMS technology, so-called MEMS microphones, are known in the prior art. MEMS is the abbreviation for microelectromechanical system and is characterized by a miniaturized and compact design, especially in the micrometer range, which has excellent functionality with ever lower manufacturing costs.

A MEMS microphone usually comprises a vibratable microphone membrane that is configured to receive pressure waves from a fluid. The fluid can be either a gaseous or a liquid fluid, preferably sound pressure waves. A MEMS microphone preferably converts pressure waves into electrical signals and is therefore a sound detector.

MEMS microphones exhibit a plurality of advantages. For example, their compact design makes them particularly easy to arrange into arrays, which can be used for sound measurements with a directional characteristic. In addition, they can be produced using widespread, extensively automated semiconductor technology processes.

It is known from the prior art to combine MEMS microphones with other measurement sensors in order to measure a plurality of measurement signals and thus cover more diverse measurement ranges or applications. For example, US 2015/0158722 A1 discloses a MEMS device comprising a MEMS microphone and a further MEMS sensor in the form of a motion sensor. In one embodiment described therein, the membrane of the MEMS microphone is present in front of a perforated back plate. The MEMS microphone is located on a substrate to which the opening for the entry of sound waves is attached. There is also another sensor on the substrate, which may be a gyroscope, an acceleration sensor or a pressure sensor, for example. In addition to the measurement of variables by the MEMS microphone and the other sensors, other information can also be measured and/or processed, such as ultrasonic waves, infrared light, temperature, humidity and/or a gas species of the environment of the MEMS device.

However, the majority of MEMS microphones are designed for audio applications, i.e. for telephones and/or hearing aids. These applications are usually characterized by a bandwidth of less than 20 kHz and a sound pressure level of less than approx. 120 dB.

In the prior art, however, there are also efforts to measure particularly low sound pressure levels, especially using microsystem technology methods. This is relevant for photoacoustic spectroscopy, for example. In photoacoustic spectroscopy, intensity-modulated radiation is used with frequencies in the absorption spectrum of a molecule to be detected in a gas. If this molecule is present in the beam path, modulated absorption takes place, which leads to heating and cooling processes whose time scales reflect the modulation frequency of the radiation. The heating and cooling processes lead to expansions and contractions of the gas, causing sound waves with the modulation frequency. These can be measured, for example using sound detectors such as MEMS microphones. The resulting sound pressures are very low.

Photoacoustic gas sensors as such are already well known in the prior art. A variant of a photoacoustic gas sensor is disclosed in US 2011/0296900 A1. Here, all components are installed in one or as a MEMS device for operational suitability. The photoacoustic gas sensor has an infrared source that is mounted on a substrate. An integrated microphone can be located on the substrate itself or on a second substrate. A filter for the infrared light is present on a third substrate.

Approaches to measuring low sound pressure levels are also known in the prior art, particularly for the purposes of photoacoustic spectroscopy. The measurement of low sound pressure levels is particularly relevant in photoacoustic spectroscopy in order to enable the detection of reliable measurement results.

Sievilä et al. (2013) disclose a cantilever production process and a sensor arrangement to measure sound pressure levels in the context of photoacoustic spectroscopy. Modulated infrared light is emitted into a sample cell containing a gas that absorbs the wavelength of the infrared light. At one end of the sample cell is a cantilever, which is deflected by the absorption of the infrared light. A Michelson-Morley interferometer is located outside the sample cell. The beam path of the Michelson-Morley interferometer is configured in such a way that it is incident on the cantilever through a transparent window. A change in the absorption of the gas also affects the position of the cantilever and therefore also the beam path of the Michelson-Morley interferometer. A change in the sound pressure is therefore measured. Further applications are not described here. The setup is particularly complex due to the use of a Michelson-Morley interferometer and is disadvantageous for a compact design of the measuring system.

With the MEMS microphones known in the prior art, it is also only to a limited extent possible to measure low sound pressure levels precisely. In particular, most measurements with MEMS microphones are unsuitable for low frequencies and only have a low signal-to-noise ratio in this range.

US 2005/0249041 A1 discloses a MEMS microphone that is said to have increased sensitivity. Among other things, the MEMS microphone of US 2005/0249041 A1 is said to have various advantages over a theoretical approach outlined in the introductory paragraphs and of US 2005/0249041 A1. According to the approach discussed, a tunnel current between a measuring tip and the membrane is kept constant by a closed control loop. For this purpose, the cantilever to which the measuring tip is attached is tracked when the membrane is set into vibration by incident sound waves. According to US 2005/0249041 A1, such a method would have the disadvantage of being highly sensitive to shocks, for example, and would be more expensive to manufacture. In addition, according to US 2005/0249041 A1, with such an approach it can happen that the resonant frequency of the cantilever falls within the range of the frequencies to be detected, which makes it difficult or even impossible to control the measuring tip. In this respect, such an approach according to the disclosure of US 2005/0249041 A1 is unsuitable for providing a MEMS microphone.

The MEMS microphone disclosed according to the teaching of US 2005/0249041 A1, however, comprises a measuring tip located on a perforated support plate, i.e. one with openings, and directly behind the microphone membrane. Sound waves cause the microphone membrane to vibrate. A tunnel current flows between the measuring tip on the support plate and the microphone membrane, which is evaluated as a measurement signal. The measuring tip itself does not move, which reduces the influence of vibrations and eliminates the need to control the movement of the measuring tip. However, losses of the sound to be detected can occur through the openings in the support plate, which means that the sound is not measured with high accuracy. Furthermore, if high sound pressures occur, the microphone membrane can touch the measuring tip, as the measuring tip is not designed to move. The measurement is therefore static. If the measuring tip and the microphone membrane come into contact, a resistive current flows instead of a tunnel current, which leads to a change in the measurement signal and can impair reliable and continuous operation.

There is therefore a need for improvement with regard to the provision of MEMS microphones for sensitive measurements, also at low sound pressure levels.

### OBJECTIVE OF THE INVENTION

The objective of the invention was to eliminate the disadvantages of the prior art and to provide a MEMS microphone with which low sound pressure levels can be measured with high resolution. Furthermore, the MEMS microphone should preferably be characterized by the possibility of particularly reliable and durable measurements as well as a cost-effective and compact design.

### SUMMARY OF THE INVENTION

The objective according to the invention is solved by the features of the independent claims. Advantageous embodiments of the invention are described in the dependent claims.

In a preferred embodiment, the invention relates to a MEMS microphone for detecting acoustic signals, comprising a sound inlet opening, a vibratable microphone membrane and an electronic circuit, wherein sound waves entering through the sound inlet opening induce the vibratable microphone membrane into vibrations, characterized in that the MEMS microphone exhibits a cantilever comprising a measuring tip and an actuator, the electronic circuit being configured for measuring a tunnel current between the microphone membrane and the measuring tip and for an active induction of the cantilever into vibrations, wherein the measuring tip is guided to the microphone membrane in a contactless vibrating manner in order to detect acoustic signals, while the measurable tunnel current permits detection of the vibration behavior of the microphone membrane as a function of the sound waves.

The MEMS microphone according to the invention has proven to be extremely advantageous in that it can precisely measure low sound pressure levels with a particularly high resolution. The MEMS microphone exhibits a significantly higher sensitivity compared to the known MEMS microphones of the prior art. This is noticeable, for example, in that a particularly high signal-to-noise ratio can be achieved despite low sound pressure levels.

The high sensitivity at low sound pressure levels is based on the advantageous measuring principle utilizing a tunnel current. Preferably, the cantilever comprising the measuring tip is guided to the microphone membrane by the actuator in a contactless vibrating manner. The distance between the measuring tip and the microphone membrane is so small that a tunnel current flows between the microphone membrane and the measuring tip due to the quantum mechanical tunnel effect. Preferably, the tunnel current flows by application of a voltage. The tunnel current depends exponentially on the distance between the microphone membrane and the measuring tip. Due to the highly sensitive dependence of the tunnel current on the distance, even the smallest changes in distance between the microphone membrane and the measuring tip can be detected by measuring the tunnel current.

As a result of an active induction of the cantilever (in particular the measuring tip) into vibrations, the distance between the measuring tip and the microphone membrane preferably changes in a periodic manner with the known periodicity of the induced vibration. This means that the tunnel current is preferably a periodic signal whose amplitude depends on the distance between the measuring tip and the microphone membrane during the vibration.

If a sound event occurs, i.e. sound waves are incident on the microphone membrane, the microphone membrane is deflected and vibrates. This changes the distance between the microphone membrane and the vibrating measuring tip. The measurable tunnel current therefore changes depending on the vibration behavior of the microphone membrane, which is dependent on the sound waves.

The device can be configured in various ways to detect acoustic signals by measuring the tunnel current (explained in detail later).

For example, analogous to a constant height mode, the detection can be carried out in such a way that the deflection and center position of the vibrating measuring tip on the cantilever is not changed, so that as a result of a vibration of the microphone membrane the distance between the microphone membrane and the measuring tip changes and thus also the tunnel current.

Alternatively, for example, the device can also be designed so that the center position of the vibration of the cantilever is adjusted to maintain a constant amplitude of the tunnel current. This configuration would correspond to a constant current mode measuring principle, wherein the tunnel current or its amplitude is used as a control variable for the center position of the vibrating measuring tip.

According to the invention, advantageous use is made in any case of the fact that the tunnel current signal is extremely sensitive even to the smallest deflections of the microphone membrane, such that extremely small changes in sound pressure level are reliably detected.

Advantageously, particularly low sound pressure levels can be measured with high accuracy using the device according to the invention. Thus, the MEMS microphone according to the invention can advantageously measure sound pressure levels which are in particular less than approx. 20 dB (decibels), preferably less than approx. 10 dB, particularly preferably less than approx. 5 dB and even less than approx. 1 dB.

It is particularly advantageous that the MEMS microphone according to the invention can measure low sound pressure levels with a particularly high signal-to-noise ratio.

Terms such as substantially, approx, etc. preferably describe a tolerance range of less than ±40%, preferably less than ±20%, particularly preferably less than ±10%, even more preferably less than ±5% and in particular less than ±1% and in particular include the exact value. Partially describes preferably to at least 5%, particularly preferably to at least 10%, and in particular to at least 20%, in some cases to at least 40%.

Furthermore, the method according to the invention is advantageous in that contact with the microphone membrane is avoided due to the ability of the measuring tip to move, in particular due to the vibration of the measuring tip. A possible contact could occur, for example in US 2005/0249041 A1, if the microphone membrane undergoes strong deflections at high sound pressure levels. Advantageously, this can be avoided by the MEMS microphone according to the invention, as the measuring tip is guided to the microphone membrane in a contactless vibrating manner. Consequently, wear is avoided and a long-lasting functionality of the MEMS microphone according to the invention is ensured.

Furthermore, the dynamic measurement of the tunnel current using a contactless vibrating measuring tip allows a highly sensitive read-off of the vibration behavior of the membrane for almost any frequency range. In particular, the modulation frequency of the vibrating measuring tip can be freely selected such that measurements can be carried out at very low (0 Hz) to very high frequencies (MHz) regardless of the excitation frequency. Due to the fact that the modulation frequency of the measuring tip is independent of the excitation frequency, a high signal-to-noise ratio can be achieved over a wide frequency range. This represents a particular advantage over known MEMS microphones, which exhibit increased noise, especially at lower frequencies.

In the context of the invention, it is preferably provided that the cantilever comprising the measuring tip performs a periodic vibration to which it is actively induced. The periodic vibration of the cantilever preferably takes place in the sense of tapping. This preferably means that the cantilever performs a continuous, periodic vibration that is independent of any movement of the microphone membrane. Instead, the measuring tip is guided to the microphone membrane in a contactless vibrating manner in order to enable the detection of any vibrations of the membrane if it is excited by sound waves. With such a contactless vibration of the cantilever in the sense of tapping, the measuring tip therefore changes the distance to the vibrating membrane, preferably in a periodic manner.

In this way, the MEMS microphone according to the invention also differs from the disadvantageous approach described in US 2005/0249041 A1 in paragraphs [0007] and [0008], in which a measuring tip of a cantilever tracks any vibrations of the membrane. In the approach described, there is no active induction of a cantilever, which is guided to the microphone membrane in a contactless vibrating manner. Instead, the distance between the measuring tip and the membrane is kept constant.

The actively induced periodic vibration of the cantilever in the sense of tapping according to the invention is therefore not to be compared with the cantilever tracking vibrations of the microphone membrane, which merely follows any movements of the membrane due to sound excitation. Instead, the actively induced periodic vibration of the cantilever occurs independently of vibrations of the microphone membrane and is maintained over the entire detection process.

This is also made clear by the fact that the vibration of the cantilever preferably occurs at a frequency many times higher (for example by a factor of 2, 3, 4 or more) than the expected vibrations of the microphone membrane. In contrast to tracking by the cantilever, a disadvantageously high sensitivity with regard to shocks can also be avoided.

Thus, by active induction of the cantilever into periodic vibrations, the measurement of sound events with high sensitivity can be advantageously ensured even at extremely low sound pressure levels. The MEMS microphone according to the invention advantageously succeeds in reducing or eliminating the influence of interference factors.

In addition, the MEMS microphone according to the invention is advantageous in that there are no flow losses of the fluid in which the sound propagates. Instead, the sound is preferably incident on the microphone membrane directly, without any distortion of the sound waves or energy losses due to other components. In this way, a particularly accurate and undistorted signal can be measured. In this respect, it may also be preferable for the MEMS microphone according to the invention to exhibit no openings other than a sound inlet opening.

Furthermore, the MEMS microphone according to the invention can be advantageously produced in a particularly process-efficient manner, since it can be provided by standardized processes of semiconductor and microsystem technology. In particular, proven, automated semiconductor processing methods can be used to implement cost-effective mass production.

The MEMS microphone according to the invention uses a new application of measuring tips that are known from scanning tunneling microscopy and can therefore also make use of known processes for producing such measuring tips. However, the measuring tip according to the invention is not used for detecting the structure of a material surface, but for acoustic purposes for detecting sound events. Thus, the MEMS microphone according to the invention efficiently combines two different technical fields in order to enable a significant improvement with regard to the detection of acoustic signals.

The MEMS microphone according to the invention represents an advantageous further development of conventional MEMS microphones, in which highly sensitive measurements of the vibration behavior of a microphone membrane are used by dynamically measuring a tunnel current and the measuring range of the MEMS microphone can be extended well below 20 dB in terms of sound pressure level. As explained above, this makes use of the fact that the distance between the measuring tip and the microphone membrane is exponentially dependent on the distance. Alternative measurement methods, such as capacitive measurement methods, only have a linear correlation between the (capacitive) measurement signal and the deflection of the microphone membrane. While the non-linearity of a MEMS microphone based on a tunnel current makes it less interesting for classic audio applications, it was recognized in accordance with the invention that the non-linearity can be exploited for highly sensitive sound detection, for example for photoacoustic spectroscopy.

A MEMS microphone preferably refers to a microphone that is based on MEMS technology and whose sound-receiving structures are at least partially dimensioned in the micrometer range (approx. 1 μm to approx. 1000 μm). The sound-receiving structures are preferably referred to as a microphone membrane. Preferably, the microphone membrane can exhibit a dimension in the range of less than 1000 μm in width, height and/or thickness.

Preferably, the microphone membrane is preferably planar, which means in particular that its expansion in each of the two dimensions (height, width) of its surface is greater than in a dimension perpendicular to this (the thickness). For example, size ratios of at least 5:1, preferably at least 10:1, 50:1 or more may be preferred.

In a preferred embodiment, the length or width of the microphone membrane is between 1 μm and 1000 μm, preferably between 10 μm and 500 μm. Intermediate ranges from the aforementioned ranges can also be preferred, such as 1 μm to 10 μm, 10 μm to 50 μm, 50 μm to 100 μm, 100 μm to 200 μm, 200 μm to 300 μm, 300 μm to 400 μm, 400 μm to 500 μm, 600 μm to 700 μm, 700 μm to 800 μm, 800 μm to 900 μm or even 900 μm to 1000 μm. A person skilled in the art will recognize that the aforementioned range limits can also be combined to obtain further preferred ranges, such as 10 μm to 200 μm, 50 μm to 300 μm or even 100 μm to 600 μm.

In a preferred embodiment, the thickness of the membrane is between 100 nm and 10 μm, preferably between 500 nm and 5 μm. Intermediate ranges from the aforementioned ranges may also be preferred, such as 100 nm to 500 nm, 500 nm to 1 μm, 1 μm to 1.5 μm, 1.5 μm to 2 μm, 2 μm to 3 μm, 3 μm to 4 μm, 4 μm to 5 μm, 5 μm to 6 μm, 6 μm to 7 μm, 7 μm to 8 μm, 8 μm to 9 μm or even 9 μm to 10 μm. A person skilled in the art will recognize that the aforementioned range limits can also be combined to obtain further preferred ranges, such as 500 nm to 3 μm, 1 μm to 5 μm or even 1500 nm to 6 μm.

In the course of the development of MEMS microphones, different types have become established. These can be categorized according to the way in which the sound is received. If the sound reaches the microphone membrane via the underside of the housing, this is referred to as a bottom-port MEMS microphone. Bottom-port MEMS microphones also require an opening on the substrate on which the components of the MEMS microphone are located (also known as the carrier substrate), as this is the only way for sound waves to reach the microphone membrane. If the sound reaches the sensor via the top of the housing, it is referred to as a top-port MEMS microphone. Whether a top-port or a bottom-port MEMS microphone is preferred usually depends on factors such as the arrangement of the microphone in the product and/or production aspects. The MEMS microphone can be a top-port MEMS microphone or a bottom-port MEMS microphone.

The microphone membrane is configured to receive pressure waves from the fluid. The fluid can be either a gaseous or a liquid fluid, preferably concerning sound pressure waves. A MEMS microphone therefore preferably converts pressure waves into electrical signals. The microphone membrane is preferably sufficiently thin such that it bends under the influence of the changes in air pressure caused by the sound waves and changes into a vibration behavior. As the microphone membrane vibrates, electrical variables can change, in particular the current strength of the tunnel current between the microphone membrane and the measuring tip. The change in an electrical variable can be measured, recorded and/or evaluated by an electronic circuit preferably built into the MEMS microphone, for example an ASIC or a computing unit. The electronic circuit preferably measures changes in such electrical variables that occur when the microphone membrane vibrates under the influence of sound waves.

The electronic circuit preferably converts the vibrations of the microphone membrane into electrical signals. The electronic circuit preferably comprises electrical connections, for example wires. Preferably, the electronic circuit is connected to the cantilever and/or the measuring tip such that the tunnel current can preferably be read out.

In addition, the electronic circuit can exhibit an ASIC (application-specific integrated circuit), a computing unit, an integrated circuit (IC), a programmable logic device (PLD), a field programmable gate array (FPGA), a microprocessor, a microcomputer, a programmable logic controller and/or other electronic circuit elements.

On the one hand, the electronic circuit is preferably configured to measure a tunnel current between the microphone membrane and the measuring tip. On the other hand, the electronic circuit is preferably configured to actively induce the cantilever into vibrations.

The formulation according to which the electronic circuit is configured to carry out a specific process step, such as the measurement of a tunnel current or an active induction of the cantilever into vibrations, preferably means that software or firmware is installed on the electronic circuit which comprises commands to carry out the said process steps.

The electronic circuit is preferably also programmable, such that settings regarding the operation of the MEMS microphone can exhibit different operating options. For example, it may be preferable that an excitation mode can be selected with regard to the measuring tip and/or the cantilever, for which purpose various operating options can be installed in the software, for example.

The sound inlet opening preferably refers to an opening in the MEMS microphone through which sound waves can pass and are incident on the microphone membrane. Preferably, the sound inlet opening is located in front of the microphone membrane in the direction of flow of the fluid, in particular air.

An acoustic signal preferably refers to an electrical signal that is generated by sound. Sound is preferably a mechanical deformation in a medium that propagates as a wave. In a fluid, sound is always a longitudinal wave, especially in air. The terms “sound” and “sound wave” can therefore be used synonymously. In gases such as air, sound can be described as a sound pressure wave superimposed on the static air pressure. In the case of sound waves, the fluctuations of the state variables pressure and density are usually small in relation to their rest variables. If air is discussed below as a fluid of sound waves, the average person skilled in the art knows that the explanations can also be applied to other fluids.

A cantilever, or synonymously bending bar, is preferably a spatially extended, in particular elongated element, which is mounted such that it can vibrate along at least one side and is otherwise preferably free-standing. The vibratable side of the cantilever can also be referred to as the free end. A cantilever can, for example, have the shape of a flat, elongated cuboid, the thickness of which is significantly smaller in comparison to the transverse and/or longitudinal extension, whereby the transverse extension is preferably smaller than the longitudinal extension. For example, it may be preferred that the cantilever exhibits a thickness of 0.1 μm to 10 μm, preferably 0.5 μm to 5 μm, a length of 10 μm to 1000 μm, preferably 20 μm to 500 μm, and a width of 5 μm to 100 μm, preferably 10 μm to 50 μm. The thickness of the cantilever is particularly relevant, as a greater thickness is associated with a reduced ability to bend. It is therefore preferred that the thickness is lower than the length and/or width by a multiple, i.e. by a factor of 2, 3, 5, 10 or more. Furthermore, it is preferred that the width is also lower than the length. However, a cantilever beam mounted on both sides or on multiple sides may also be preferred. The cantilever can be present in various designs, which are preferably relevant for the selection of the actuator.

The cantilever can preferably be a unimorph or monomorphic cantilever, which preferably comprises an active layer and an inactive or passive layer. An active layer preferably refers to a piezoelectric layer in which a force or deformation is triggered by an applied electric field, in particular by applying an electric control voltage (which can be generated by the electronic circuit). This force or deformation preferably generates a deflection and/or a deformation of the bar, which can preferably trigger an active vibration by means of a periodic electrical control signal. The inactive layer preferably comprises a non-piezoelectric material. It is preferred that the active layer and inactive layer interact in such a way that a resulting force is generated due to the applied control voltage, which causes a deflection of the bar, which preferably causes a vibration when the electrical control signal oscillates. It may also be preferred that the inactive layer also comprises a piezoelectric material which, however, is not in electrical contact with and/or controlled by a control signal, to which advantageously no electrical control signal is applied and which in particular does not experience an external electric field which triggers an internal force and/or a deformation due to the indirect piezoelectric effect of the inactive layer.

Likewise, the cantilever can preferably be a bimorph cantilever, which preferably comprises at least two active layers. Preferably, an inactive layer can be present between the at least two active layers. It is preferred that when an electrical voltage is applied, one active layer contracts while the second active layer expands, which advantageously results in a bending of the cantilever that is amplified in particular compared to a unimorph cantilever, e.g. has a greater amplitude for the same applied voltage.

Preferably, the cantilever comprises a measuring tip. The measuring tip is preferably located substantially at the free end of the cantilever. The electronic circuit is configured to cause the cantilever and thus also the measuring tip to vibrate in such a way that the measuring tip is guided in a vibrating and contactless manner to the microphone membrane, wherein the distance is so small that a tunnel current flows between the microphone membrane and the measuring tip. The measuring tip and the microphone membrane are preferably made of electrically conductive material. It is also preferred that the cantilever is vibrated in such a way that the measuring tip is guided to the microphone membrane in a substantially vertical, contactless vibrating manner. Preferably, the measuring tip exhibits only a few atomic layers at its pointed end. For example, the measuring tip can exhibit a cross-section of less than 50 nm², preferably less than 20 nm², particularly preferably less than 10 nm² at its pointed end.

In preferred embodiments, the measuring tip can be designed as an additional component on the cantilever and connected to the cantilever. In further preferred embodiments, the cantilever and the measuring tip are present as a common component. Preferably, the measuring tip is characterized in terms of its geometric shape by the fact that the lateral lines meet at a common point, this common point preferably being the pointed end of the measuring tip.

A vibration is preferably defined as a repeated temporal fluctuation of the spatial deflection of the cantilever and thus in particular also of the measuring tip from a center position. In particular, the vibration is substantially or at least partially periodic, which means above all temporally regular. The cantilever is actively induced by the actuator into periodic vibrations, wherein the measuring tip is guided to the microphone membrane in a contactless vibrating manner in order to detect acoustic signals. The vibration of the cantilever or the measuring tip is thus preferably independent of the movements of the membrane, although the measuring tip is moved towards the membrane in a periodic manner in the sense of tapping without touching it. Contactless vibration therefore preferably means that the cantilever vibrates in such a way that the measuring tip does not touch the microphone membrane during the vibration. In particular, contact between the measuring tip and the microphone membrane is also avoided when the microphone membrane is induced into vibrations by the impact of sound waves. In particular, contact between the microphone membrane and the cantilever is avoided in order to maintain a tunnel current and preferably to avoid a resistive current. Contact between the measuring tip and the microphone membrane in constant height mode can be avoided, for example, by adapting the amplitude of the cantilever and thus the measuring tip to the expected deflections of the microphone membrane. In constant current mode, for example, contact between the measuring tip and microphone membrane can be avoided by regulating their distance from each other using a closed control loop in order to maintain a constant tunnel current.

Periodic vibrations, especially when viewed over a plurality of periods, can preferably be described by the vibration mode of the vibration. The vibration mode is preferably a form of description of certain temporally stationary properties of a vibration. Different vibration modes differ in particular in the spatial distribution of the vibration intensity, wherein the shape of the vibration modes is preferably determined by boundary conditions under which the vibration propagates. These boundary conditions can be given, for example, by the material, the dimensions and/or the mounting of the cantilever and preferably at least one force vector acting on the cantilever. The cantilever's ability to vibrate means, in particular, that the cantilever can be induced into vibrations mechanically over a longer period of time by a suitable drive in the form of an actuator without structural changes (damage) occurring.

In a vibrating cantilever, for example, there may be a plurality of bending vibration modes in which the cantilever bends along a preferred direction, e.g. perpendicular to a plane of the cantilever suspension, which may differ in particular in vibration frequency, maximum vibration amplitude and spatial occurrence. This corresponds in particular to the vibration of the measuring tip. A bending vibration mode is characterized in particular by the fact that the vibration describes a dynamic bending process in the direction substantially of a perpendicular to a main level of the cantilever. Preferably, the measuring tip, which is preferably located at the free end, is guided in a contactless periodic manner to the microphone membrane by the vibration, resulting in a tunnel current between the microphone membrane and the measuring tip.

In addition to the cantilever, the actuator is preferably also suitable for inducing such vibrations. In particular, the electronic circuit is operatively connected to the actuator in such a way that the actuator fulfills the function of active induction of the cantilever. The active induction of the cantilever preferably means actively inducing the cantilever into vibrations. In particular, it is preferred that the cantilever is positively caused to vibrate by the actuator.

The actuator is a component that converts an electrical signal, preferably originating from the electronic circuit, into a mechanical movement and/or a change in a mechanical variable. In particular, the actuator actively causes the cantilever to vibrate. The actuator must be suitable for transmitting a force generated by it to the cantilever, e.g. by being connected to the cantilever in a manner that enables force transmission.

Preferably, the cantilever can also at least partially comprise the actuator. The force itself must be suitable for triggering the vibrations, which means in particular that the force is periodic and preferably exhibits substantially the frequency of the vibrations of the cantilever to be generated and is suitable for causing the cantilever and thus also the measuring tip to vibrate, preferably in a vibration mode.

The tunnel current preferably refers to an electric current that flows between the microphone membrane and the measuring tip even though they are not in mechanical contact. In other words, the tunnel current refers to an electric current that flows despite a barrier between the microphone membrane and the measuring tip, wherein the barrier refers in particular to a potential barrier that results from the gap due to a non-existent contact between the microphone membrane and the measuring tip. Preferably, the tunnel current in the context of the invention is the measurand that allows detection of the vibration behavior of the microphone membrane as a function of the sound waves. Preferably, it is possible to use the tunnel current to measure various sound variables of the sound waves that induce the microphone membrane into vibrations. Sound variables such as sound deflection, sound pressure, sound pressure level, sound energy density, sound energy, sound flux, sound velocity, sound impedance, sound intensity, sound power, sound velocity, sound amplitude and/or sound radiation pressure can be determined by measuring the tunnel current.

The tunnel current is based on the tunnel effect, which is known from quantum mechanics or quantum physics, i.e. a quantum mechanical or quantum physical effect and cannot be explained by the laws of classical physics. According to the laws of classical physics, there is a potential barrier, i.e. an energy barrier, between the measuring tip and the microphone membrane, which prohibits the transfer of charge carriers, especially electrons. The potential barrier is associated in particular with the work function.

From the perspective of quantum physics, the temporal change of the non-relativistic system is described by the Schrödinger equation. Non-relativistic means in particular that the effects of the theory of relativity can be disregarded here. The Schrödinger equation is a partial differential equation whose solution is the wave function, which in turn describes the state of particles, in particular their location. Even in the “forbidden” region, i.e. within and/or beyond the potential barrier, the wave function is nowhere equal to zero, but decays exponentially with increasing penetration depth. Even at the end of the forbidden range, its value is therefore not zero. Since the magnitude squared of the wave function is interpreted as a probability density for the location of the particle, there is a non-zero probability for the particle to appear on the other side of the potential barrier. As this is a quantum mechanical effect, the tunnel effect is also referred to as the quantum physical or quantum mechanical tunnel effect.

To use the quantum mechanical tunnel effect to maintain the tunnel current, an electrical voltage is preferably applied that can range from a few mV (millivolts) to a few V (volts). Preferably, the measuring tip is at a distance in the Angstrom range (10⁻¹⁰ m (meters)) from the microphone membrane during the contactless vibration. Due to the applied voltage and the small distance, a tunnel current flows between the microphone membrane and the measuring tip. The tunnel current is substantially dependent on the distance, the applied voltage and the work function of the materials used.

The measurable tunnel current is usually associated with low currents, which typically range from a few pA (picoampère) to a few nA (nanoampère range) and sometimes even up to a few mA (milliampere range). Therefore, even small deviations in the current strength of the tunnel current as a measurement signal can be recorded particularly clearly, as the tunnel current is exponentially dependent on the distance and the smallest changes in the distance lead to a considerable change in the tunnel current as a measurement signal.

In a further preferred embodiment, the MEMS microphone is characterized in that the cantilever vibrates with a frequency of more than 20 kHz (kilohertz), preferably more than 50 kHz, particularly preferably more than 100 kHz.

The specified frequencies of the vibration of the cantilever are preferably many times higher than the expected vibrations of the microphone membrane resulting from the impact of sound waves. The frequency of the vibration of the cantilever is preferably a factor of at least 2, 3, 4, 5, 10, 15, 20, 50, 100, 200, 500, 1000 or more higher than possible frequencies of the microphone membrane.

Advantageously, the vibration behavior of the cantilever is independent of the vibration of the microphone membrane due to the specified frequencies of its vibration. This advantageously means that the microphone membrane can vibrate in a wide frequency range and that reliable detection of an acoustic signal by the tunnel current is also ensured. As it is preferable for the cantilever to vibrate at a much higher frequency than the microphone membrane, it is possible to measure sound events permanently, reliably and with high accuracy. The specified frequencies have proven to be particularly efficient for simply and effectively generating and measuring a tunnel current between the microphone membrane and the measuring tip. Advantageously, the MEMS microphone according to the invention can be used to precisely detect a wide frequency range of the microphone membrane, in particular from very low frequencies (<10 Hz) up to high frequencies in the kHz or even MHz range.

In another preferred embodiment, the MEMS microphone is characterized in that the electronic circuit is arranged to keep an amplitude and a center position of an vibration of the measuring tip and/or the cantilever constant, wherein a change in an amplitude of the tunnel current between the microphone membrane and the measuring tip is measured, wherein the amplitude of the tunnel current depends on the vibration behavior of the microphone membrane.

The embodiment in the last disclosed paragraph corresponds to the so-called constant height mode in analogy to scanning tunneling microscopy. In this case, the measuring tip of the scanning tunneling microscope follows a previously specified height profile without the distance between a sample to be examined and the measuring tip of the scanning tunneling microscope having to be readjusted.

The principle of the constant height mode can be advantageously transferred to the MEMS microphone for the detection of sound events by a tunnel current according to the invention. In this case, the electronic circuit is preferably configured such that the amplitude and the center position of the cantilever and/or the measuring tip do not change. A center position of the cantilever and/or the measuring tip preferably denotes a spatial position that serves as a reference point for the amplitude of the vibration. The amplitude of the vibration is preferably the maximum deflection of the cantilever and/or the maximum displacement of the measuring tip around the center position. The amplitude, in particular the maximum displacement, can preferably be specified by a variable with the dimension of a distance. Preferably, the amplitude is set in such a way that, with regard to expected deflections of the microphone membrane, contact between the microphone membrane and the measuring tip is avoided.

In preferred embodiments, the cantilever, and thus in particular the measuring tip, performs vibrations that exert deflections in the range from pm (picometers) to nm (nanometers) and μm (micrometers).

To illustrate the measurement principle, two cases are considered, namely a theoretical case in which the microphone membrane is not induced into vibrations by sound waves, but is substantially stationary, and the actual case in which the microphone membrane is induced into vibrations by sound waves.

In the theoretical case, in which the microphone membrane substantially performs no vibrations, there is a fixed distance between the microphone membrane and the center position of the cantilever and/or the measuring tip, provided that the cantilever and thus also the measuring tip perform vibrations with a constant amplitude around a constant center position. This means that the tunnel current also has a constant amplitude, as the distance between the microphone membrane and the measuring tip only changes as the cantilever vibrates.

Sound waves that are incident on the microphone membrane through the sound inlet opening cause it to vibrate. Due to the vibrations of the microphone membrane, there is now no fixed distance between the center position of the cantilever and/or the measuring tip and the microphone membrane. In particular, the distance between the microphone membrane and the measuring tip changes depending on the vibration behavior of the microphone membrane. The higher the sound pressure level, the more the microphone membrane is deflected. The more the microphone membrane is deflected, the smaller the distance between the measuring tip and the microphone membrane, resulting in a measurable increase in the tunnel current.

Conversely, the lower the sound pressure level of the incident sound waves, the weaker the deflection of the microphone membrane and the lower the tunnel current.

The changes in the signal strength of the tunnel current thus directly reflect the vibration behavior of the microphone membrane, which is dependent on the incident sound waves.

Advantageously, the measuring principle of a constant height while maintaining a constant amplitude and center position of the vibration of the cantilever and/or the measuring tip is particularly easy to configure and allows high-frequency vibrations of the cantilever to be induced in a robust manner.

In another preferred embodiment, the MEMS microphone is characterized in that the electronic circuit is arranged to keep an amplitude of the tunnel current between the microphone membrane and the measuring tip constant, wherein the vibration of the cantilever and/or the measuring tip is regulated to keep a distance between the microphone membrane and a center position of the measuring tip constant.

The embodiment in the last disclosed paragraph corresponds to the so-called constant current mode in analogy to scanning tunneling microscopy. Here, the height of the measuring tip is continuously changed so that the tunnel current remains constant. In the scanning tunneling microscope, this is done via a closed control loop to regulate the distance between the measuring tip and the sample to be examined.

The principle of the constant tunnel current mode from scanning tunneling microscopy can be advantageously transferred to the detection of sound events by a tunnel current according to the invention. It is preferable that the electronic circuit is configured to keep the amplitude of the tunnel current between the microphone membrane and the measuring tip constant. For this purpose, the vibration of the cantilever and/or the measuring tip is regulated in such a way that the distance between a microphone membrane and a center position of the measuring tip remains constant.

In particular, the center position of the measuring tip indicates the reference point for the amplitude of the vibration of the measuring tip. The center position of the cantilever does not have to be identical to the center position of the measuring tip. The measuring tip is preferably located substantially at the free end of the cantilever and also exhibits a certain spatial extension. The center position of the measuring tip therefore refers to the position at which the amplitude of the vibration of the measuring tip can be described. As the cantilever surrounds the measuring tip and vibrates, the measuring tip exhibits the same vibration pattern as the cantilever, i.e. the course of the vibration is substantially the same.

It is preferable that the amplitude of the tunnel current remains constant by keeping the distance between the center position of the measuring tip and the microphone membrane constant. Preferably, this is achieved by a closed control loop. Preferably, the tunnel current is adjusted to a predetermined amplitude by the closed control loop during a vibration, in particular a deflection, of the microphone membrane. Preferably, this is done by adjusting the distance between the center position of the measuring tip and the deflection of the microphone membrane. The closed control loop is a circuit that can be configured, for example, by the electronic circuit of the MEMS microphone. The closed control loop performs the tasks of measuring, comparing and adjusting. This means that the tunnel current is measured by the closed control loop, the amplitude of the measured tunnel current is compared with a specified value and adjusted accordingly in the event of a deviation. Preferably, the amplitude of the tunnel current is adjusted by adjusting the center position of the measuring tip. For this purpose, it is preferred that the cantilever (comprising the measuring tip) performs a translational movement in order to adjust the distance between the measuring tip and the microphone membrane. Preferably, such a translational movement of the cantilever is performed by a further actuator. In preferred embodiments, the further actuator for performing the translational movement of the cantilever may be a MEMS-based actuator. For example, a MEMS actuator can be a microactuator that is connected to the cantilever by coupling elements.

To illustrate the measurement principle, as above, two cases are considered, namely an idealized case in which the microphone membrane substantially does not vibrate and an actual case in which the microphone membrane is induced into vibrations by sound waves.

In the theoretical case, in which the microphone membrane substantially does not vibrate, the distance between the center position of the measuring tip and the microphone membrane does not change. The tunnel current has a constant amplitude. The closed control loop recognizes that it is not necessary to adjust the distance between the center position of the measuring tip and the microphone membrane, as there is no deviation from a predetermined amplitude of the tunnel current.

If sound waves are incident on the microphone membrane through the sound inlet opening, the membrane is set into vibration. The vibrations of the microphone membrane initially change the distance between the microphone membrane and the center position of the measuring tip. This also has an effect on the tunnel current, in particular the amplitude of the tunnel current deviates from a specified value. A change in the amplitude of the tunnel current is detected by the closed control loop. In particular, the closed control loop can be used to make a comparison between the predetermined and the measured tunnel current, for example by establishing a difference and/or a ratio. In order to then regulate the tunnel current back to the specified value, the distance of the center position of the measuring tip is adjusted such that the specified amplitude of the tunnel current is reached again.

The higher the sound pressure level, the more the microphone membrane is deflected. The more the microphone membrane is deflected, the greater the change in the distance between the center position of the measuring tip and the microphone membrane, which must be adjusted using the control variable of a tunnel current that must be kept constant.

Conversely, the lower the sound pressure level of the incident sound wave, the weaker the deflection of the microphone membrane. The weaker the deflection of the microphone membrane, the smaller the change in the distance between the center position of the measuring tip and the microphone membrane, which must be adjusted based on the measured tunnel current.

Controlling the distance based on the control variable of the tunnel current to be kept constant makes it possible to measure sound signals with particularly high sensitivity and accuracy. A closed control loop also allows the vibration behavior of the microphone membrane to be tracked very precisely, which not only allows conclusions to be drawn about the frequency and sound pressure level of the sound signals, but also the entire temporal course.

In a further preferred embodiment, the MEMS microphone is characterized in that the electronic circuit is configured to apply a bias voltage to the microphone membrane such that a zero point position and/or vibration capability of the microphone membrane can be regulated.

Advantageously, the sensitivity of the microphone membrane can be regulated and/or adjusted by applying a bias voltage to the microphone membrane. In the context of the invention, a bias voltage refers to an electrical voltage that is applied such that the microphone membrane attains a curvature that exceeds a zero point position of the microphone membrane. The zero point position of the microphone membrane preferably refers to the force-free rest position of the microphone membrane when there is no deflection by sound waves and no bias voltage is applied. Thus, the application of a preload can cause the positioning of the microphone membrane to deviate from the zero point position and/or cause the microphone membrane to exhibit a curvature that deviates from the zero point position. It is preferable that the bias voltage can be regulated by the electronic circuit.

Advantageously, applying a bias voltage allows the sensitivity of the microphone membrane to be regulated. If a bias voltage is applied, this has an effect on the microphone membrane's ability to vibrate. The higher the applied bias voltage, the lower the microphone membrane's ability to vibrate. The lower the applied bias voltage, the higher the microphone membrane's ability to vibrate. This makes it possible to precisely adjust the sensitivity of the microphone membrane in particular.

The sensitivity of the microphone membrane preferably refers to the ability to undergo a deflection, wherein the deflection is dependent on the sound pressure levels of the sound waves entering through the sound inlet opening.

The regulation of the vibration capability of the microphone membrane is advantageous in that an optimum adaptation of the MEMS microphone to different sound pressure levels can be ensured, particularly with regard to the small distances when a tunnel current occurs. Thus, the MEMS microphone according to the invention exhibits a high dynamic range and is advantageously suitable for a wide range of sound signals to be measured.

In a further preferred embodiment, the MEMS microphone is characterized in that the MEMS microphone exhibits a sensitivity which allows sound pressure waves with a sound pressure level of less than 20 dB, particularly preferably less than 10 dB, less than 5 dB, less than 1 dB or less than 0 dB to be measured.

Advantageously, the MEMS microphone according to the invention can measure low sound pressure levels, such as those just indicated, with extreme precision. The sound pressure level (abbreviated to SPL) is the decadic logarithm of the square ratio between the effective value of the measured sound pressure and its reference value of 20 μPa (micropascals), which is commonly used in acoustics. This is advantageous for measuring sound pressure levels with a high signal-to-noise ratio.

It is also advantageous that the compact MEMS microphone according to the invention can measure sound events with high resolution despite a low sound pressure level. The lateral resolution here preferably refers to a resolution transverse to the course of a measurement path by means of sound waves. The opposite of lateral resolution is axial resolution along the longitudinal course of the measurement path, i.e. the path of the sound. In particular, the lateral resolution is the distance between two adjacent objects, e.g. two sound sources, which can be mapped as two points. This makes it advantageously possible to create a very accurate image of a sound field, despite low sound pressure levels.

Low sound pressure levels are also particularly relevant in the context of photoacoustic spectroscopy, such that the MEMS microphone according to the invention can be used efficiently, preferably for photoacoustic measurements. Other advantageous uses of the MEMS microphone according to the invention are also possible. Low sound pressure levels can also be generated by machines, such as lighting fixtures. This makes the MEMS microphone according to the invention advantageously suitable for monitoring devices where low sound pressure levels are relevant. Advantageously, the MEMS microphone can be used optimally and efficiently in a variety of possible applications.

In a further preferred embodiment, the MEMS microphone is characterized in that the electronic circuit is configured such that the actuator regulates the vibration of the cantilever in such a way that there is a distance of between 0.1 nm and 100 nm between maximum deflections of the measuring tip and the vibratable microphone membrane. Intermediate values such as maximum distances between 1 nm and 50 nm or 0.5 nm and 10 nm may also be preferred.

The distance range between the measuring tip and the microphone membrane is regulated in particular by the center position of the vibration of the cantilever and/or the amplitude of the vibration excitation. The distance range mentioned has proven to be particularly advantageous in order to be able to measure the vibration behavior of the membrane with high resolution by means of the tunnel current on the one hand and to effectively avoid contact between the measuring tip and the membrane on the other. The MEMS microphone according to the invention is therefore characterized by a long-term stable measurement capability.

In a further preferred embodiment, the MEMS microphone is characterized in that the actuator induces the cantilever comprising the measuring tip into vibrations, preferably the actuator is selected from a group comprising a piezoelectric actuator, an electrostatic actuator, an electromagnetic actuator, a magnetostrictive actuator and/or a thermal actuator.

The aforementioned actuators are particularly suitable for inducing a large number of fast vibrations and exhibit a low energy requirement, especially due to their compact design. The bandwidth of the achievable vibrations is also advantageously high due to the compact design and the low inertia.

Preferably, the actuator is a MEMS actuator. A MEMS actuator is preferably an actuator that is produced using conventional microsystems technology production methods and also exhibits dimensions in the order of μm (micrometers). Such an actuator is particularly compact, robust and low-maintenance and can be produced easily and cost-effectively. In particular, the cantilever, which is induced into vibrations by the actuator, can also be a MEMS element. Preferably, this means that the cantilever and the actuator can be produced in one manufacturing step with the MEMS actuator and are compact. Desirably, the same substrate can be used in parts for production. This considerably simplifies and reduces the cost of production.

A piezoelectric actuator preferably refers to an actuator that utilizes the piezoelectric effect. In particular, a piezoelectric actuator can induce the cantilever into vibrations using the inverse piezoelectric effect. The piezoelectric effect comprises the direct piezoelectric effect, which describes the occurrence of an electrical voltage during the deformation of certain solid bodies, in particular piezoelectric crystals, and the inverse piezoelectric effect, in which a deformation is induced by applying an electrical voltage. Preferably, a piezoelectric actuator comprises a piezoelectric crystal that deforms when an electrical voltage is applied. Depending on the piezo crystal and the profile, it becomes longer, wider and/or bends.

An electrostatic actuator preferably uses electrostatic fields to move components, in particular the cantilever. For this purpose, the cantilever preferably exhibits a material that reacts to the electrostatic fields used. An electromagnetic actuator converts electrical energy into mechanical energy. The effects of electromagnetism are preferably used. In a thermal actuator, a heat source is preferably used to generate movements of the cantilever in particular.

Magnetostrictive actuators are preferably based on the change in length of ferromagnetic materials. Magnetostrictive actuators are preferably manufactured using sintering techniques and change their length under magnetic fields. These actuators can also be used advantageously under high pressures and temperatures as positioning elements with high positioning accuracy in the micrometer range.

In a further preferred embodiment, the MEMS microphone is characterized in that the vibratable microphone membrane comprises an electrically conductive material, wherein preferably the electrically conductive material is selected from a group comprising monosilicon, polysilicon, molybdenum, tantalum, aluminum, graphite, tungsten, titanium, platinum, gold, palladium, iron, copper, silver, brass, chromium, their compounds and/or alloys, wherein optionally the vibratable microphone membrane comprises an additional non-electrically conductive material, which is preferably selected from a group comprising silicon nitride and/or silicon dioxide.

These materials are easy and inexpensive to process in semiconductor and/or microsystem production and are suitable for large-scale production. The microphone membrane can be produced flexibly based on the materials and/or production methods. In particular, it is preferably possible to produce the MEMS microphone comprising the vibratable microphone membrane together with a carrier in one (semiconductor) process, preferably on a substrate. This further simplifies and reduces the cost of production, such that a compact and robust MEMS microphone can be provided at low cost.

In addition, the listed materials are advantageous in that they are characterized by a particularly inert behavior. Due to their inertness, they do not react with the environment in which the MEMS microphone according to the invention is to be mounted, such that a particularly robust and hard-wearing MEMS microphone can be advantageously provided.

Preferably, electrically conductive material is used here, in particular to ensure that the tunnel current is maintained.

It is also preferable to provide the microphone membrane with semi-conductive and/or dielectric materials. Dielectric materials preferably mean electrically non-conductive materials. In particular, dielectric materials are preferably introduced into the microphone membrane in such a way that they are embedded within the microphone membrane. Advantageously, the semi-conductive and/or dielectric materials preferably used in the microphone membrane result in the membrane being mechanically supported. The sensitivity and thus the vibration capability of the microphone membrane can also be advantageously adjusted in this way.

In another preferred embodiment, the MEMS microphone is characterized in that the cantilever and/or the measuring tip comprises a material selected from a group comprising silicon, iridium, tungsten, platinum, palladium and/or gold.

These materials advantageously exhibit the desired electrical, mechanical and/or thermal properties to allow a tunnel current to flow particularly efficiently between the microphone membrane and the measuring tip. Furthermore, the materials can be processed very easily and cost-effectively to provide the cantilever and/or the measuring tip.

The tunnel current is particularly relevant with regard to the provision of the measuring tip in terms of dimensioning. In particular, the measuring tip can be designed in such a way that one atom is the foremost tip of the measuring tip and/or is responsible for the majority of the tunnel current.

In a further preferred embodiment, the MEMS microphone is characterized in that the measuring tip exhibits a radius of up to 15 nm, preferably up to 10 nm, particularly preferably up to 5 nm.

In a further preferred embodiment, the MEMS microphone is characterized in that the cantilever exhibits a length of up to 1000 μm, a width of up to 100 μm and a thickness of up to 10 μm.

The listed dimensions of the cantilever and/or the measuring tip have proven to be advantageous in that, on the one hand, they enable a particularly reliable tunnel current between the microphone membrane and the measuring tip and, on the other hand, they are designed to vibrate optimally such that the guidance to the microphone membrane can be carried out particularly efficiently, for example by the actuator.

The average person skilled in the art will recognize that technical features, definitions and advantages of preferred embodiments which apply to the MEMS microphone for detecting acoustic signals according to the invention also apply to a method for detecting acoustic signals comprising the MEMS microphone according to the invention, and vice versa.

In a further aspect, the invention relates to a method for detecting acoustic signals comprising a MEMS microphone comprising a sound inlet opening, a vibratable microphone membrane and an electronic circuit, wherein sound waves entering through the sound inlet opening induce the vibratable microphone membrane into vibrations, characterized in that the MEMS microphone exhibits a cantilever comprising a measuring tip and an actuator, the cantilever and/or the measuring tip being actively induced into vibrations by the actuator and being guided in a contactless vibrating manner to the microphone membrane, such that a tunnel current is measured between the measuring tip and the microphone membrane and the tunnel current permits detection of the vibration behavior of the microphone membrane as a function of the sound waves.

The method for detecting acoustic signals comprising the MEMS microphone according to the invention advantageously permits high-resolution measurement of low sound pressure levels. Thus, sound pressure levels can be measured which are in particular less than 20 dB (decibels), preferably less than 10 dB, particularly preferably less than 5 dB, most preferably less than 1 dB, whereby it is particularly advantageous that the low sound pressure levels can be measured with a particularly high signal-to-noise ratio.

The average person skilled in the art knows that the signal-to-noise ratio describes the ratio of the actual signal component to the noise component. The signal-to-noise ratio can be better quantified by expressing it in dB. Noise is any interference that can affect the signals. The signal-to-noise ratio can therefore be used to evaluate the reception quality of the received signals. The higher the signal-to-noise ratio, the lower the noise component compared to the useful or measurement signal and the easier it is to filter out. Particularly in the context of measuring low sound pressure levels, the signal-to-noise ratio was not high in the prior art, as the influence of noise is weighted more heavily. It is therefore particularly advantageous that the MEMS microphone according to the invention can also measure at low sound pressure levels with a comparatively high signal-to-noise ratio.

Measurement with the aid of a tunnel current enables extremely sensitive measurement, as even the slightest deviations are clearly recognizable, in particular due to the low current intensity of the tunnel current.

At the same time, contact between the measuring tip and the microphone membrane can be advantageously avoided, enabling reliable, long-term stable and safe measurement of the vibration behavior of the microphone membrane and thus of the incident sound waves.

In addition, the measurement can advantageously be carried out without flow losses of the fluid in which the sound propagates, such that a particularly accurate image of the sound field is possible.

In a further aspect, the invention relates to the use of the MEMS microphone according to the invention or preferred embodiments thereof for photoacoustic spectroscopy.

In a further aspect, the invention relates to a photoacoustic gas sensor comprising
a modulable emitter,
an analysis volume that can be filled with gas and
a MEMS microphone according to the invention or a preferred embodiment thereof
wherein the modulable emitter and the MEMS microphone are arranged in such a way that the emitter can excite gas in the analysis volume by means of modulably emittable radiation to form sound pressure waves, which can be detected with the aid of the MEMS sensor.

The average person skilled in the art will recognize that technical features, definitions and advantages of preferred embodiments of the MEMS microphone according to the invention also apply to the method or use according to the invention and to a photoacoustic gas sensor comprising a described MEMS microphone and vice versa.

The basic features or essential components of a photoacoustic gas sensor are known to the person skilled in the art. A modulable emitter generates electromagnetic radiation and is preferably arranged and configured in such a way that the radiation emitted by the infrared emitter is substantially or at least partially incident on the gas in the analysis volume.

If the modulated irradiation is carried out with a wavelength that corresponds to the absorption spectrum of a molecule of a gas component in the gas mixture, modulated absorption takes place, which leads to heating and cooling processes whose time scales reflect the modulation frequency of the radiation. According to the photoacoustic effect, the heating and cooling processes lead to expansions and contractions of the gas component, causing it to form sound pressure waves with substantially the modulation frequency. The sound pressure waves are also referred to as PAS signals and can be measured particularly sensitively using the MEMS microphone as described. The power of the sound waves is preferably directly proportional to the concentration of the absorbing gas component. Due to the possibility of measuring extremely low sound level pressures using the MEMS microphone according to the invention, even the smallest proportions of gas components can be detected advantageously.

Various emitters are preferred as radiation sources for the applications mentioned. For example, narrow-band laser sources can be used. These advantageously allow the use of high radiation intensities and can be modulated with standard components for photoacoustic spectroscopy, preferably at high frequencies. Preferably, broadband emitters can also be used. These advantageously exhibit a broad spectrum, which can be further selected, e.g. by using (tunable) filters. Preferably, the modulable emitter is a modulable infrared emitter.

In one embodiment, the modulable emitter can be a thermal emitter comprising a heating element, wherein the heating element comprises a substrate on which a heatable layer of a conductive material is at least partially applied, on which contacts for a current and/or voltage source are present. The heating element comprises a heatable layer made of a conductive material which produces Joule heat when an electric current flows through it. In particular, the heating element comprises a substrate on which the heatable layer is present. The substrate preferably forms the base of the heating element. The substrate can also at least partially comprise other elements of the IR emitter, such as the base element and/or housing elements.

The emitter can be modulated, which means that the intensity of the emitted radiation, preferably the intensity of the beam, can be changed in a controllable manner over time. The modulation should preferably cause a change in intensity over time as a measurable variable. This means, for example, that there is a difference in intensity over time between the weakest intensity measured within the measurement period and the strongest intensity measured within the same period, which is greater than the sensitivity of a device typically used for the radiation spectrum and the application for measuring or determining the intensity. Preferably, the difference is significantly greater than a factor of 2, more preferably 4, 6 or 8 between the strongest and the weakest intensity that can be set. Particularly preferably, the intensity of the modulated beam can be modulated for one or more predetermined resonance wavelengths.

Preferably, direct modulation can be carried out by varying the current supply. With a thermal emitter, such modulation is usually limited to a certain range of a modulation spectrum based on thermal time constants, e.g. in the range of an order of magnitude of up to 100 Hz. In the case of a laser or LED, for example, significantly higher modulation rates, e.g. in the kHz range and beyond, are preferably possible.

The emitter can preferably also be modulated by external modulation, e.g. by using a rotating chopper wheel and/or an electro-optical modulator.

The gas to be analyzed is preferably located in an analysis volume that can be filled with gas. In a preferred embodiment, this is a volume (or chamber) that is at least partially closed or sealable to the outside, in which the gas is located or can be introduced, e.g. through a sealable opening in the form of a closure and/or valve and/or through a supply line. However, it can also be a completely closed or sealable volume or chamber, which exhibits at least one, preferably two, sealable openings for introducing and/or discharging the gas to be analyzed. In this way, the gas to be analyzed can be localized very well, especially in a beam area of the emitter, for example infrared radiation.

The analysis volume can preferably also be at least partially open. In particular, this allows a gas atmosphere surrounding the spectroscope, to which the analysis volume is at least partially open, to be measured and its composition verified. This is of particular interest for applications in the field of pollutant measurement, but also, for example, for military applications or for counter-terrorism, e.g. due to a poison gas attack.

In this case, it is advantageous that the analysis volume is well defined such that the emitter, the analysis volume and the MEMS microphone are arranged in such a way that the modulable radiation emitted by the emitter can excite gas in the analysis volume to form sound pressure waves, which can be measured with the aid of the MEMS microphone.

The analysis volume is preferably located in the beam path of the emitter. This preferably means that the intensity of the beam substantially or at least partially impinges on the side of the analysis volume facing the emitter. Partially means preferably at least 40%, preferably at least 50%, 60%, 70%, 80% or more.

An analysis volume can be formed by a chamber. However, it may also be preferable for the analysis volume to comprise a sample chamber and a reference chamber, which are connected or can be connected by a connecting channel.

In the case of an embodiment of an analysis volume comprising a sample chamber and a reference chamber, it may be preferable to position a MEMS microphone in each chamber in order to measure separately in each chamber and thus to be able to eliminate sources of interference, e.g. external sound pressure waves, which do not originate from the radiation absorbed in the sample chamber, preferably after the measurement.

It may also be preferred that the emitter irradiates the sample chamber and not the reference chamber and that there is a connecting channel between the sample chamber and the reference chamber in which the MEMS microphone is located as a sound detector. The sample volume and reference volume can contain the same gas. It may also be preferred that the sample volume and the reference volume contain different gases, with a gas with known properties being present in the reference volume and a gas to be analyzed being present in the sample volume. This embodiment is characterized by particularly precise photoacoustic spectroscopy, since, for example, sound from unwanted sound sources is eliminated or not measured during the measurement and/or evaluation of the measurement. Preferably, the sample volume and a reference volume can exhibit substantially the same dimensions in order to realize an accurate differential measurement method.

The MEMS microphone according to the invention will be explained in more detail below using examples, without being limited to these examples.

### FIGURES

### Brief Description of the Figures

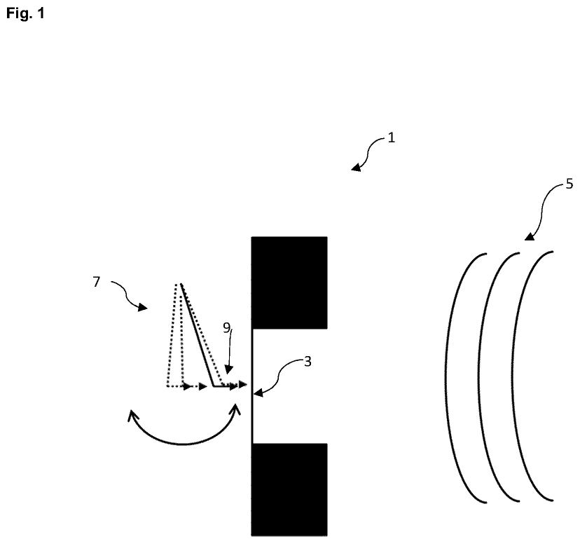

FIG. 1 Schematic representation of a preferred MEMS microphone

### DETAILED DESCRIPTION OF THE FIGURES

FIG. 1 shows a schematic representation of a preferred MEMS microphone 1. As explained above, the MEMS microphone 1 is particularly suitable for measuring low sound pressure levels with high resolution.

The MEMS microphone 1 comprises a vibratable microphone membrane 3. When a sound event occurs, sound waves 5 propagate from a sound source in the direction of the MEMS microphone 1 through a sound inlet opening and are incident on the microphone membrane 3, which is then induced into vibrations. Furthermore, the MEMS microphone 1 exhibits a cantilever 7 comprising a measuring tip 9. Other components such as an electronic circuit and an actuator are not shown in FIG. 1.

The electronic circuit is configured such that the cantilever 7 comprising the measuring tip 9 is actively induced into vibrations, wherein the actuator can be used to transmit the vibration. The vibration of the cantilever 7 and thus of the measuring tip 9 is illustrated by the dashed line and the curved arrow below the measuring tip 9. The measuring tip 9 and the microphone membrane 3 comprise electrically conductive material. The measuring tip 9 is brought so close to the microphone membrane 3, in a vibrating contactless manner, that a tunnel current (not shown) flows based on the quantum mechanical tunnel effect. The tunnel current reflects the vibration of the measuring tip 9 as a periodic signal, as the distance between the measuring tip 9 and the microphone membrane changes in a periodic manner. The measurable tunnel current makes it possible to detect the vibration behavior of the microphone membrane 3, which is dependent on the sound waves 5, in particular on variables such as the sound pressure level and/or the frequency.

Advantageously, the MEMS microphone 1 can be used to measure low sound pressure levels with a high signal-to-noise ratio, as the tunnel current can measure the smallest deflections of the microphone membrane 3 particularly precisely due to the exponential dependence on the distance.

The MEMS microphone 1 is also advantageous in that contact between the measuring tip 9 and the microphone membrane 3 is avoided particularly reliably. Furthermore, no flow losses of the sound occur, such that a particularly accurate sound image can be generated. The MEMS microphone 1 can therefore measure sound pressure levels with a high degree of precision and reliability and accurately detect even the smallest deviations.

The cantilever 7 and thus also the measuring tip 9 perform vibrations that are significantly faster than the expected vibrations of the vibratable microphone membrane 3, such that the vibration of the cantilever 7 and/or the measuring tip 9 is also advantageously independent of the vibration of the microphone membrane 3. As a result, the microphone membrane 3 can vibrate in a wide frequency range while at the same time reliably and particularly sensitively detecting sound waves by means of the tunnel current.

The MEMS microphone 1 can exhibit different operating modes.

The electronic circuit can thus be configured such that an amplitude and a center position of a vibration of the measuring tip 9 and/or the cantilever 7 are kept constant. A change in the amplitude of the tunnel current is measured, providing information about the vibration behavior of the microphone membrane 3 and sound parameters such as the sound pressure level of incident sound waves 5.

Furthermore, the electronic circuit can be configured in such a way that an amplitude of the tunnel current between the microphone membrane 3 and the measuring tip 9 is kept constant. This is achieved by regulating a vibration of the cantilever 7 and thus of the measuring tip 9 in such a way that a distance between the microphone membrane 3 and a center position of the measuring tip 9 is kept constant. This is achieved in particular by means of a closed control loop, which can be provided by the electronic circuit, for example. In this case, the necessary distance adjustment between the microphone membrane 3 and a central position of the measuring tip 9 allows direct conclusions to be drawn about the vibration behavior of the membrane and therefore the incident sound waves 5.

### REFERENCE LIST

1 MEMS microphone
3 Vibratable microphone membrane
5 Sound waves
7 Cantilever
9 Measuring tip

### BIBLIOGRAPHY

Sievilä, Päivi, et al. “Sensitivity-improved silicon cantilever microphone for acousto-optical detection.” Sensors and Actuators A: Physical 190 (2013): 90-95.

1. A MEMS microphone for detecting acoustic signals, comprising a sound inlet opening, a vibratable microphone membrane and an electronic circuit, wherein sound waves entering through the sound inlet opening induce the vibratable microphone membrane into vibrations, wherein the MEMS microphone exhibits a cantilever comprising a measuring tip and an actuator, the electronic circuit being configured for measuring a tunnel current between the vibratable microphone membrane and the measuring tip and for an active induction of the cantilever into vibrations, wherein, for the detection of acoustic signals, the measuring tip is guided to the vibratable microphone membrane in a contactless vibrating manner, while the measurable tunnel current permits detection of the vibration behavior of the vibratable microphone membrane which is dependent on the sound waves, wherein the cantilever performs due to the active induction periodic vibrations, wherein the distance between the measuring tip and the vibratable microphone membrane changes with the periodicity of the active induction.

2. The MEMS microphone according to claim 1, wherein the cantilever is configured to use active induction to perform periodic vibrations independent of a vibration behavior of the vibratable microphone membrane.

3. The MEMS microphone according to claim 1, wherein the electronic circuit is arranged to keep an amplitude and a center position of a vibration of the measuring tip and/or the cantilever constant, wherein a change in an amplitude of the tunnel current between the vibratable microphone membrane and the measuring tip is measured, wherein the amplitude of the tunnel current depends on the vibration behavior of the vibratable microphone membrane.

4. The MEMS microphone according to claim 1, wherein the electronic circuit is arranged to keep an amplitude of the tunnel current between the vibratable microphone membrane and the measuring tip constant, wherein a vibration of the cantilever and/or the measuring tip is regulated to keep a distance between the vibratable microphone membrane and a center position of the measuring tip constant.

5. The MEMS microphone according to claim 1, wherein the electronic circuit is configured to apply a bias voltage to the vibratable microphone membrane such that a zero point position and/or vibration capability of the vibratable microphone membrane can be regulated.

6. The MEMS microphone according to claim 1, wherein the MEMS microphone exhibits a sensitivity which allows sound pressure waves with a sound pressure level of less than 20 dB to be measured.

7. The MEMS microphone according to claim 1, wherein the electronic circuit is configured such that the actuator regulates the vibration of the cantilever in such a way that there is a distance of between 0.1 nm and 100 nm between maximum deflections of the measuring tip and the vibratable microphone membrane.

8. The MEMS microphone according to claim 1, wherein the actuator induces the cantilever comprising the measuring tip into vibrations, wherein preferably the actuator is selected from the group consisting of a piezoelectric actuator, an electrostatic actuator, an electromagnetic actuator and a thermal actuator.

9. The MEMS microphone according to claim 1, wherein the vibratable microphone membrane (3) comprises an electrically conductive material.

10. The MEMS microphone according to claim 1, wherein the cantilever and/or the measuring tip comprises a material selected from the group consisting of silicon, iridium, tungsten, platinum, palladium and gold.

11. The MEMS microphone according to claim 1, wherein the measuring tip exhibits a radius of up to 15 nm.

12. The MEMS microphone according to claim 1, wherein the cantilever exhibits a length of up to 1000 μm, a width of up to 100 μm and a thickness of up to 10 μm.

13. A Method for detecting acoustic signals comprising a MEMS microphone comprising a sound inlet opening, a vibratable microphone membrane and an electronic circuit, wherein sound waves entering through the sound inlet opening induce the vibratable microphone membrane (3) into vibrations, wherein the MEMS microphone exhibits a cantilever comprising a measuring tip and an actuator, the cantilever and/or the measuring tip being actively induced into vibrations by the actuator and being guided to the vibratable microphone membrane in a contactless vibrating manner, such that a tunnel current between the measuring tip and the vibratable microphone membrane is measured and the tunnel current permits detection of the vibration behavior of the vibratable microphone membrane dependent on the sound waves, wherein the distance between the measuring tip and the vibratable microphone membrane changes with the periodicity of the active induction.

14. A method of performing photoacoustic spectroscopy and/or infrared spectroscopy comprising using the MEMS microphone according to claim 1.

15. A Photoacoustic gas sensor comprising
a modulable emitter,
an analysis volume that can be filled with gas, and
a MEMS microphone according to claim 1, wherein the modulable emitter and the MEMS microphone are arranged in such a way that the emitter can excite gas in the analysis volume by means of modulably emittable radiation to form sound pressure waves, which can be detected with the aid of the MEMS sensor.

16. The MEMS microphone according to claim 1, wherein the cantilever is configured to use active induction to perform periodic vibrations independent of the vibration behavior of the vibratable membrane with a frequency of more than 20 kHz.

17. The MEMS microphone according to claim 16, wherein the periodic vibrations independent of the vibration behavior of the vibratable microphone membrane are at a frequency of more than 50 kHz.

18. The MEMS microphone according to claim 9, wherein the electrically conductive material is selected from the group consisting of monosilicon, polysilicon, molybdenum, tantalum, aluminum, graphite, tungsten, titanium, platinum, gold, palladium, iron, copper, silver, brass, chromium, their compounds and alloys.

19. The MEMS microphone according to claim 9, wherein the vibratable microphone membrane comprises an additional non-electrically conductive material.

20. The MEMS microphone according to claim 19 wherein the additional non-electrically conductive material is selected from the group consisting of silicon nitride and silicon dioxide.
